(19) United States
(12) Patent Application Publication
(10) Pub. No.: US 2009/0278852 A1
(43) Pub. Date: Nov. 12, 2009

(54) Control of 3D objects in a light displaying device

(75) Inventors: Charles Reese, Dallas, TX (US); Mark Hunt, Derby (GB)

Correspondence Address: Law Office of Scott C Harris Inc, PO Box 1389, Rancho Santa Fe, CA, 92067, US

(73) Assignee: PRODUCTION RESOURCE GROUP L.L.C, New Windsor, NY (US)

(21) Appl. No.: 12/118,584

(22) Filed: May 9, 2008

(51) Int. Cl. G06T 15/00

(52) U.S. Cl. 345/581

(57) ABSTRACT

Transition effects on 3D objects are carried out in a shader of a graphic processing unit.

### BACKGROUND

Production Resource Group LLC's patents and patent applications describe different ways in which control can be carried out on digital lighting and digital lighting systems. Many of these controls may use very sophisticated ways of controlling the shape and content of a projected light beam.

For example, U.S. Pat. No. 5,828,485 describes using a digital, pixel level based control, to control the outer shape of a beam of light, like an analog gobo. These digital control techniques can also be used to control shapes within the light beam.

### SUMMARY

The present application describes additional effects which can be carried out in a digital lighting beam. A specific aspect describes control of simulated three dimensional shapes within the projected beam.

### BRIEF DESCRIPTION OF THE DRAWINGS

FIG. 1 shows a block diagram; and

FIG. 2 shows a flowchart of 3D effects;

### DETAILED DESCRIPTION

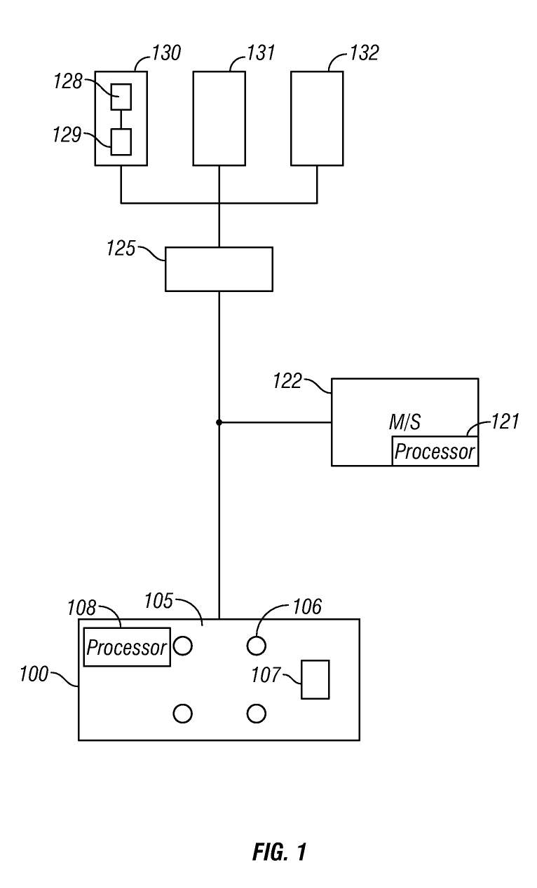

FIG. 1 illustrates a basic block diagram of a digital lighting system. A controlling part 100 may include an operator console 105 that includes a number of operator operable controls such as 106. Each control may control a specific function of a controlled light. A display 107 may be provided so that an operator can select from a menu of different effects. A media server 110 may include different effects that can be used and can also alter these effects. A control line 120 connects between the hardware. The control line can be an Ethernet line, or a bundle of wires, or one or more lines carrying control signals of DMX512 format.

The connection can be direct or through a hub 125 to a number of controlled lights. Each light such as 130, 131, 132 may be a light or projector or other device that produces output light that is capable of being controlled on a pixel by pixel basis, e.g., based on spatial light modulators such as DMDs. These lights are referred to throughout this specification as digital lights. Various kinds of light effects are controllable in this way. These lights are typically computer based lights with dedicated video processing cards having graphic processing units (GPUs).

The features of this kind of light can be controlled in a number of different ways. First, while the media server 122 can be globally located for plural different lights, there can alternatively be media servers in each light, or reduced-function versions of the media servers in each light. Alternatively, the lights may store information that is usable within the light to control images and shapes within the light beam. Different kinds of processing can be carried out on the shapes within the light beam.

The present application describes a number of different effects that can be carried out on the light. Any of these effects can be controlled by any of a number of different processors. For example, there may be a processor 108 that operates certain operations in the console. A processor 121 may also be located in the media server. Control processors are also located at the lights, such as processor 129, in addition the graphic processor 128. Any of these processors may carry out the effects which are described herein.

These effects are described for use in digital lights that project light onto a stage. For example, a preferred digital light may use a bulb having an output of 200 W or more, more preferably 700 W or more.

According to an embodiment, many of these functions are carried out as a function of a shader on a graphics board 128 within the light itself.

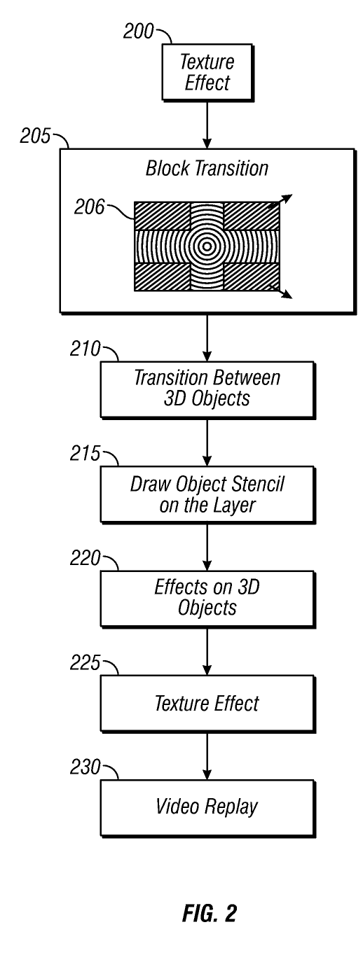

Many of the functions, as described herein, are carried out in the flowchart of FIG. 2. A first function that can be carried out is a texture effect. Any of these functions can be individually selected, or can be selected as a combined function. The textures can be controlled by the shaders in the GPU, and software may also control the scene to show at least one 3D image within the scene, with the texture modifying the 3D image.

The texture effect 200 forms a dynamic rippling effect based on pseudo-randomized sine wave image effects to sections of the image as arranged in an graphical, e.g., x,y grid. This may produce, for example, intensity effects in the grid. The intensity effects, for example areas where the intensity gets more and less bright. The sine wave sets the areas that are processed in this way.

This may create, for example, a rippling effect, for example, that may look like projecting on a curtain, where some parts are more intense, other parts less intense. The rippling effect itself is formed by making a combination of randomized intensity variation along with randomized x,y motion. The intensity changes in a random fashion, according to a sine wave envelope, where the increase may be at the peak of the sine wave and the intensity decrease may be at the valley of the sine wave.

The sinusoidal intensity variation may travel in both x and y directions. For example, the sine wave motion may move the horizontally and vertically. This causes a rippling effect across the image as in essence aligning across the image; first appearing brighter, then dimmer according to a sine wave motion.

Functions other than sine waves may be used, e.g., square waves, triangular waves, and others. Also, noise and/or psuedonoise, may be added on top of the sine wave to add a random character to the effect.

The effect may be used by itself, or on top of any image but preferably a 3D image.

Flicker effects may also have strobe effects where there the strobe causes on/off effects in an x,y motion.

The flicker effect may be randomized as a whole, making the projection look like a candle. the overall intensity of the image may be effected by the flicker effect, with some areas (set by the x,y sinusoidal travelling wave) being more intensity effected.

Another texture effect may use a roll effect, where the 3D image rolls left, right, or up or down or diagonally at some angle, with variable pauses in between the rolls.

Vertical and horizontal and as described above may look like a rolling or non-synced television.

Transitions can also be used with the rolls. For example, the transition may also break the image into bars, and move them off of the projection area, from any direction.

As an alternative, the image may be broken into blocks, and the blocks may be faded in and out for any directions.

When splitting the image into strips or blocks, an image moves out towards the edge to reveal the incoming image that is underneath the overall image. The strips may move at a variable or random speed based on the direction of motion. The outgoing image splits into strips which move out towards two opposite edges to reveal the incoming image underneath. When dividing into blocks, there can be multiple blocks, e.g., four blocks that each move toward an edge of the screen. The outgoing image blocks, for example, may be as shown in 205, where the original image 206 is divided into four different blocks to show the underlying image as the original image is divided up and moves towards the edges. Eventually, the blocks forming the divided portions of the old image move all the way off the screen, leaving only the incoming image showing.

For any of the texture-modification embodiments, the image/video and the effect can be on a single layer in this system, and the transitions remains on that single layer. Also, the embodiment makes it preferable for these operations to be done in a shader in the video processing unit, with the shader processing all the information on the single layer.

210 illustrates transitions between 3-D objects. This corresponds to switching from the current object to a different object. The outgoing object is transitioned to the incoming object, all on the same layer. This allows a control for transition type (which objects), transition time (time over which the transition takes place), and transition modifier (information of the transition). Different transitions are possible on the layer.

In one embodiment, the outgoing object scales down while the incoming object scales up. This scale of the outgoing object is changed from 100 (normal size) towards zero (where the object has zero size). When reaching zero, the outgoing object resets and is removed.

The outgoing object can also move in the x,y plane. For example, the incoming object may move in from a first direction, while the outgoing object moved out from the opposite direction. This may also come at an angle, for example at a 45 or 30° angle. The angle of motion may be one of the values set by the modifier as the objects move on the plane.

In another embodiment, the outgoing object moves out on the z-axis, essentially fading towards zero as the incoming object moves in on that z-axis.

In yet another embodiment, the incoming object may collide with the outgoing object at an angle defined by the modifier channel. The outgoing object moves off screen based on a collision, where each of the objects obey the laws of motion.

Another transition may allow the objects to rotate in and out of the screen using a rotary motion as if on a global wheel. The angle is defined by the modifier channel. The objects rotate as they enter the screen and again rotate as they leave the screen.

In another embodiment, the objects rotate in and out as an orbiting one another, again at an angle defined by the modifier channel.

The objects may rotates in the same direction, with the incoming object rotating with a radius that is that becomes progressively smaller, while the outgoing object rotates with an a radius that becomes progressively larger.

Another embodiment uses an outgoing object which spins rapidly and transitions to the incoming object spinning in the same direction. That is, as the objects slow down, it in essence morphs between the new object and the old object. Another mode may use the opposite tactic, where the outgoing object spins rapidly and transitions towards the incoming object spinning in the opposite direction.

Another embodiment controls how a three-dimensional object is rendered on the layer shown as 215. This may use different modes to determine how a 3D object is rendered on the layer.

For example, this may provide an automated ambient lighting of an object using the outlines of the object to define a stencil. The stencil creates a flat layer with a transparent area. The outlines of that object is used to define a stencil representing the outside perimeter of the 3D object. It creates a flat layer with a transparent object based on that perimeter. That transparent area can be interior to the object or exterior to the object.

In a first mode, everything but the object is blocked out, leaving only the object as lit. The object's texture is drawn on the black space, but the remaining parts are blocked, making a lighting effect as though only the object is lit.

In a second mode, all areas other than the object is lit.

220 represents effects on 3-D object is that can be carried out with this processing system. The effects are used to modify a visible 3-D object with an effect. The visible 3-D object is masked at least partly by the effect. Different controls can be used for modifying this effect.

A masking effect can be controlled to mask in a linear direction. For example, the masking can be from the left or from the right or from the bottom or top of the layer or object being modified.

Another effect may use this system to move the rotational center of the object in the x,y plane. This causes the way the 3D object rotates to vary.

Different effects can include dynamically shaking the object or dynamically strobing the object, or creating multiple instances of the object in a grid. Since the object is a three-dimensional object, the position of the object may also be modified, for example in the z direction.

A specular highlight effect may also be carried out where a portion of the object is highlighted relative to another portion of the object.

Scale and rotation effect can also be added to the texture applied to the object. In another embodiment, the x, y position of the texture applied to the object can be changed.

The specular highlight may also provide shadow to different points. The texture can be mapped to any portion of the object, or can change the x,y position where it's located.

225 represents effects which can be carried out to a text or rich text font format files. Text can be displayed as a layer over another object. The text is displayed in the font and size provided in the files. The nontext area becomes transparent on the layer in the area of the text. The text area is colored by the object. Hence, the text file becomes rendered as an image colored by the object.

230 represents a video replay mode, where a special video replay is carried out at the end of the video segment. Once reaching the end of the video, the system cross fades from the last frame of the video to the first frame of the video. A cross fading may be carried out at the end point using the current transition mode and time. As the movie approaches the end point, a transition from the currently playing frame at the end of the movie is carried out to the frame at the beginning of the movie. The advantage of this is that the end of the video is cross faded into the new video on a pixel by pixel or pixel block by pixel block basis.

In this embodiment, texture operations may be carried out in the pixel shaders, but the other items are carried out in code. Many of these objects are three-dimensional related, and the claims need to stay transitions between three-dimensional objects.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other commands and command forms can be used. Other images and processing can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. a method comprising:
forming an image indicative of a three-dimensional object within a scene to be projected by a hardware device that produces an output that is controllable on a pixel by pixel basis; and
forming a texture effect over the scene which changes intensity of areas of the three-dimensional object according to a periodic function, said forming causing some parts of the three-dimensional object to appear more bright, and other parts to appear less bright based on the function, and wherein the function changes value periodically, to change the location that appears more bright and less bright based on said change of said function.

2. A method as in claim 1, wherein said motion is an x,y motion.

3. A method as in claim 2, wherein said function is a sine wave.

4. A method as in claim 3, wherein said intensity increases at a maximum point of the sine wave, and decreases at a minimum point of the sine wave.

5. A method as in claim 1, wherein said forming an image is carried out in software, and said forming a texture effect is carried out in a shader of a graphic processing unit within said hardware device.

6. A method as in claim 1, further comprising adding noise to said periodic function to randomize the periodic function.

7. A method, comprising:
displaying a first three-dimensional image;
determining a second three-dimensional image to be displayed in place of said first three-dimensional image; and
transitioning between displaying said first three-dimensional image and said second three-dimensional image on a single image layer.

8. A method as in claim 7, wherein said transition is carried out in a shader within a video processing unit.

9. A method as in claim 7, wherein said transition comprises scaling said first three-dimensional image down to a smaller scale while scaling up said second three dimensional image up to a larger scale.

10. A method as in claim 7, wherein said transitioning comprises moving said first three-dimensional image out of a display area, while moving said second three-dimensional image in the display area.

11. A method as in claim 10, wherein said transitioning comprises dividing the first three-dimensional image and moving it off the screen in divided form with different parts of the divided image moved in different directions.

12. A method as in claim 7, wherein said transitioning comprises rotating the first three-dimensional image in a first direction and rotating the second three-dimensional image in a second direction, and varying radii of said rotating, where one radius of rotating becomes progressively smaller and the other radius of rotating becomes progressively larger.

13. An apparatus, comprising:
a video display unit, having a graphic processing unit, said video display unit producing an output that indicates a display;
a controller, controlling a display to be displayed by said video display unit, said controller including a first software driven part, and at least one hardware part including shaders therein, and said at least one hardware part capable of processing plural different image layers, said controller controlling displaying a first three-dimensional image, determining a second three-dimensional image to be displayed in place of said first three-dimensional image and transitioning between displaying said first three-dimensional image and said second three-dimensional image on a single image layer.

14. An apparatus as in claim 13, wherein said transition is carried out in a shader within a video processing unit.

15. An apparatus as in claim 13, wherein said transition comprises scaling said first three-dimensional image down to a smaller scale while scaling up said second three dimensional image up to a larger scale.

16. An apparatus as in claim 13, wherein said controller controls displaying the three dimensional image using said software driven part, and controls displaying textures using said shaders.

17. An apparatus as in claim 13, wherein said controller controls moving a display of said first three-dimensional image out of a display area, while moving said second three-dimensional image into the display area.

18. An apparatus as in claim 13, wherein said transitioning comprises dividing the first three-dimensional image and moving it off the screen in divided form with different parts of the divided image moved in different directions.

19. An apparatus as in claim 13, wherein said transitioning comprises rotating the first three-dimensional image in a first direction and rotating the second three-dimensional image in a second direction, and varying radii of said rotating, where one radius of rotating becomes progressively smaller and the other radius of rotating becomes progressively larger.
